(19) United States
(12) Patent Application Publication
(10) Pub. No.: US 2016/0200010 A1
(43) Pub. Date: Jul. 14, 2016

(54) HEATING DEVICE FOR HEATING THE EDGES OF THE FILLING OPENING OF A TUBE

(71) Applicant: IWK VERPACKUNGSTECHNIK GMBH, Stutensee (DE)

(72) Inventors: Philipp STOLL, Königsbach-Stein (DE); Jürgen ZAILER, Walzbachtal (DE); Roland GATZKE, Weingarten (DE)

(21) Appl. No.: 14/912,690

(22) PCT Filed: Aug. 26, 2014
(86) PCT No.: PCT/EP2014/002325

§ 371 Date: Feb. 18, 2016

(30) Foreign Application Priority Data
Sep. 2, 2013 (DE) 10 2013 014 484.1

(51) Int. Cl. B29C 35/04; B65D 33/00; B65B 51/20; B29C 57/10; B65B 7/14

(52) U.S. Cl. CPC B29C 35/045; B29C 57/10; B65B 7/14; B65B 51/20; B65D 33/00; B29K 2105/258

(57) ABSTRACT

A heating device, for heating the edges of a filling opening of a tube with hot gas, has a hot gas nozzle with a first nozzle section, which can be inserted into an inner space of the tube. A first hot gas duct with a first hot gas outlet, may be arranged within the inner space of the tube to send hot gas can to the inner wall of the tube. In addition, the hot gas nozzle has a second nozzle section, which has a second hot gas duct with at least one second hot gas outlet, which may be arranged on the outside of the tube wall and to send hot gas to the outer wall of the tube. A flow control device is arranged in the first hot gas duct and/or in the second hot gas duct.

### CROSS REFERENCE TO RELATED APPLICATIONS

This application is a United States National Phase Application of International Application PCT/EP2014/002325 filed Aug. 26, 2014 and claims the benefit of priority under 35 U.S.C. §119 of German Patent Application 10 2013 014 484.1 filed Sep. 2, 2013 the entire contents of which are incorporated herein by reference.

### FIELD OF THE INVENTION

The present invention pertains to a heating device for heating the edges of the filling opening of a tube comprising individual tubular tube bodies by means of hot gas, with a hot gas nozzle, which has a first nozzle section, which can be inserted into an interior space of the tube body and which has a first hot gas duct with at least one first hot gas outlet, which can be arranged within the interior space of the tube body and by means of which hot gas can be sent to the inner wall of the tube body.

### BACKGROUND OF THE INVENTION

Tubes, which usually consist of a plastic or a laminate, are passed through different work stations and are filled and closed in these in a tube-filling machine. To close the tube, the wall of the tubular tube body is heated in the area of the upper filling opening to the extent that the material of the tube body will melt or becomes at least so soft that the tube can be closed or sealed by means of clamping jaws, which act on the tube body on the outside and compress the end of the tube.

To heat the material of the tube body, a corresponding heating device has a hot gas nozzle, which can be inserted into the interior space of the tube body. After inserting the hot gas nozzle into the interior space of the tube body, a hot gas and especially hot air is fed via a hot gas duct and blown onto the inner wall of the tube body by means of a hot gas outlet, as a result of which the tube wall will melt. A corresponding heating device is described in DE 37 44 402 C2.

The hot gas discharged at the hot gas outlet flows through the heating device and is subsequently removed from this. After heating the wall of the tube body, the wall is compressed in the usual manner and the tube is thus closed.

A tube-filling machine must equally process tubes consisting of different materials and also with different tube wall thicknesses. Since the cycle time, i.e., the time that is available for a sufficient heating of the tube wall, is very short in a modern tube-filling machine, problems arise with certain types of tubes in terms of a uniform and sufficient heating of the tube material to guarantee a reliable closure of the tube. To solve this problem, it would be necessary to prolong the cycle time, but this would lead to a substantial reduction in the performance capacity of the tube-filling machine.

Graphics, whose color is highly sensitive to an excessively intense heating, are printed on the outsides of the tube body in certain fields of application. It is difficult in this case, on the one hand, to introduce the necessary thermal energy that is needed for a reliable closing of the tube body rapidly into the material of the tube body and, on the other hand, to ensure that the printing on the outside of the tube body will not be damaged.

### SUMMARY OF THE INVENTION

A basic object of the present invention is to create a heating device for heating the edges of the filling opening of a tube comprising an individual tubular tube body by means of hot gas, with which sufficient but gentle heating of the wall of the tube body is guaranteed within a short cycle time independently from the type of the tube or the material of the tube.

This object is accomplished according to the present invention by a heating device for heating the edges of a filling opening of a tube comprising an individual tubular tube body by means of hot gas. The heating device comprises a hot gas nozzle comprising a first nozzle section, which can be inserted into an inner space of the tube body and which has a first hot gas duct with at least one first hot gas outlet, which can be arranged within the inner space of the tube body, and by means of which hot gas can be sent to the inner wall of the tube body and a second nozzle section, which has a second hot gas duct with at least one second hot gas outlet, which can be arranged on the outside of the wall of the tube body and by means of which hot gas can be sent to the outer wall of the tube body and the heating device comprises a flow control device arranged in the first hot gas duct or in the second hot gas duct or in the first hot gas duct and in the second hot gas duct. Provisions are made here for the hot gas nozzle to additionally have a second hot gas duct with at least one second hot gas outlet, which can be arranged on the outside of the wall of the tube body and by means of which hot gas can be sent to the outer wall of the tube body, and for a flow control device to be arranged in the first hot gas duct and/or in the second hot gas duct.

A basic idea of the present invention is to let hot gas, preferably hot air, flow directly to the wall of the tube body from both the inside and the outside. Since the tube wall is heated in this way simultaneously from the inside and the outside, substantially more thermal energy can be introduced into the tube wall within the cycle time, so that sufficient heating of the tube wall, with which reliable closure of the tube is achieved in the downstream pressing station, is guaranteed.

Furthermore, provisions are made for a flow control device to be arranged in the first hot gas duct and/or in the second hot gas duct. At least the second hot gas duct preferably has a corresponding flow control device, with which the quantity of gas that flows through the second hot gas duct and is sent to the outside to the tube wall can be changed. Provisions are made in a simple embodiment of the flow control device for the second hot gas duct to be fully opened or closed as desired. However, provisions are preferably made for the gas flow in the second hot gas duct to be able to be adjusted in terms of the flow rate at least in steps. It is, however, especially advantageous that the flow control device has a continuously adjustable blocking device, with which the gas flow and hence the quantity of gas can be adjustable continuously. A corresponding blocking device may be, for example, a slide, a diaphragm or a continuously adjustable throttle.

As an alternative or in addition hereto, provisions may be made for also providing a corresponding flow control device of the above-described design in the first hot gas duct, through which the hot gas is sent to the inner wall of the tube body.

Provisions are made in a preferred embodiment of the present invention for a cooling gas duct, through which a cooler gas, for example, ambient air, can be mixed with the hot gas flowing in the hot gas duct, opening in the first hot gas duct and/or in the second hot gas duct downstream of the respective flow control device. The temperature of the hot gas, which is flowing through the hot gas ducts, can be set in this manner to a lower temperature in one or both hot gas ducts by adding a cooler gas, which is especially meaningful when the material forming the tube body does not tolerate an excessive thermal load or if the tube body has a temperature-sensitive printing on it.

An adjustable blocking device, which may be a continuously adjustable slide or a continuously adjustable throttle, is preferably arranged in the cooling gas duct or in both cooling gas ducts.

To monitor the temperature of the hot gas flowing in the hot gas duct or in both hot gas ducts, provisions may be made in a variant of the present invention for a temperature sensor being arranged in the first hot gas duct and/or in the second hot gas duct for detecting the temperature of the gas flowing in the hot gas duct. The temperature sensor sends a corresponding temperature value to an analyzer, which can act on the flow control devices and/or the adjustable blocking devices of the cooling gas ducts as a function of the temperature values detected in order to thus set a desired temperature of the hot gas or to maintain it at a constant value.

The hot gas of the hot gas nozzle is preferably fed into a feed duct, from which both the first hot gas duct and the second hot gas duct originate. The embodiment with a common feed duct simplifies the design. It is, however, also possible to associate independent hot gas feeds, in which hot gas having different temperatures and/or different compositions can be fed, with both the first hot gas duct and with the second hot gas duct each.

Provisions may be made in a variant of the present invention for a hot gas flow control device, with which the flow rate of the hot gas and hence also the velocity of flow and the gas pressure can be set and changed, to be arranged in the feed duct.

The inner, first hot gas outlet may be located directly opposite the outer, second hot gas outlet, i.e., act on the same wall section from opposite sides when viewed in the longitudinal direction of the tube body. Provisions are, however, preferably made for the inner, first hot gas outlet to be arranged offset by a small amount of, for example, 5 mm relative to the outer, second hot gas outlet in the longitudinal direction of the tube body. The risk that the tube wall will be heated locally too intensely and damaged is reduced in this way.

Provisions may be made in a variant of the present invention for the inner, first hot gas outlet to be arranged under the outer, second hot gas outlet.

To achieve a compact design of the hot gas nozzle, provisions may be made according to the present invention for the inner, first nozzle section to be arranged radially within the outer, second nozzle section and to be surrounded by same. The first nozzle section preferably sits an inner, first ring channel, through which the hot gas is fed to the first hot gas outlet.

The inner, first ring channel is surrounded, at a spaced location, by an outer, second ring channel, which is part of the second hot gas duct and through which the hot gas is fed to the outer, second hot gas outlet.

After the hot gas has acted on the wall of the tube body, it is removed from the hot gas nozzle in the usual manner through a discharge duct in a defined manner. Provisions may be made in this connection according to the present invention for the hot gas being discharged from the first hot gas outlet and the hot gas being discharged from the second hot gas outlet to be able to be removed by means of a common discharge duct. The discharge duct may be designed as a ring channel, which at least partially surrounds the hot gas nozzle.

Further details and features of the present invention can be found in the following description of an exemplary embodiment with reference to the drawings.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a vertical sectional view through a heating device according to the present invention with a partially schematic view of individual components.

### DESCRIPTION OF THE PREFERRED EMBODIMENTS

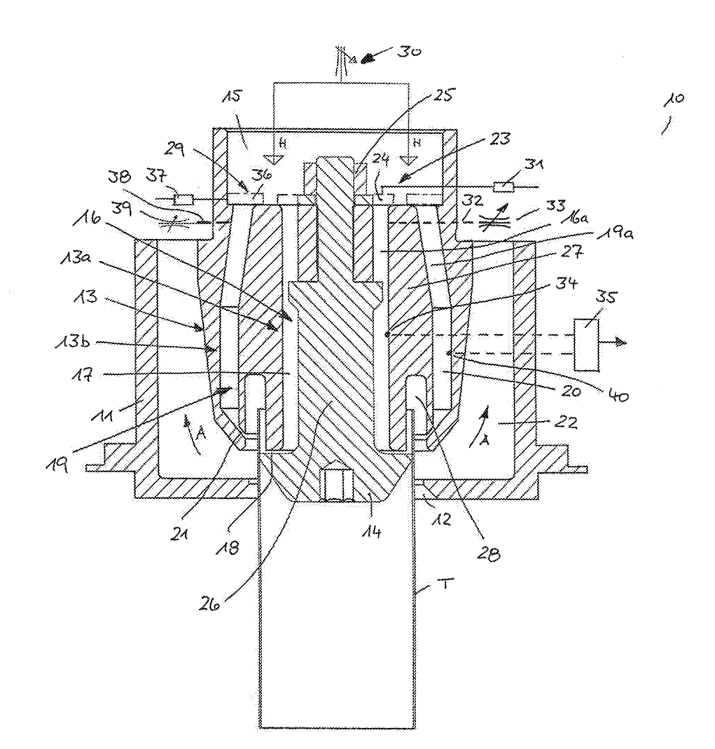

FIG. 1 shows a heating device 10, with which the edges of a filling opening of an individual tube body T of a tube, consisting of a plastic, can be heated by means of hot gas, for example, hot air. The heating device 10 has a housing 11, in which a lower insertion opening 12 is formed, whose width is somewhat larger than the diameter of the tube body T. A hot gas nozzle 13, which has an inner, first nozzle section 13a, which has a first hot gas duct 16 and can be inserted into the interior space of the tube body T, and an outer, second nozzle section 13b, which has a second hot gas duct 19 and is arranged on the outside of the tube body T, is arranged within the housing 11. A vertical holding bar 26, at the lower end of which a conical screening element 14 is formed, which can dip into the inner space of the tube body T and shall prevent the hot gas from coming into contact with a product present in the tube body T, is mounted in the hot gas nozzle 13 via a bracket 25.

A first ring channel 17, which is connected at its upper end, via a first connection duct 16a, with a feed duct 15, in which a hot gas is fed, as is indicated by the arrows H, is formed between the holding bar 26 and a first cylinder wall 27.

A hot gas flow control device 30, for example, in the form of an adjustable throttle, with which the quantity of the hot gas being fed can be set and changed, is arranged in the feed line for the hot gas, which said feed line is shown only schematically.

The first connection duct 16a and the first ring channel 17 are part of the first hot gas duct 16, which has, at its lower end, an essentially radially outwardly pointing, first hot gas outlet 18, which is formed between the top side of the screening element 14 and the lower edge of the first cylinder wall 27.

A first flow control device 23, which maybe, for example, a continuously adjustable blocking device 24 in the form of a slide or a throttle, is arranged at the site at which the first connection duct 16a opens into the feed duct 15. By setting the first flow control device 23 by means of an actuating device 31, which is shown only schematically, a user can set the amount of hot gas that shall flow through the first, inner hot gas duct 16 or fully block the first hot gas duct 16.

A first cooling gas duct 32, which is shown only schematically and in which a continuously adjustable blocking device 33, for example, in the form of a slide or a throttle is arranged, opens into the first connection duct 16a downstream of the first flow control device 23. By setting the blocking device 33, a user can set whether a cooler gas, for example, ambient air, shall be added to the hot gas flowing in the first, inner hot gas duct 16 and if so, in what amount, in order to thus set the temperature of the hot gas, which is sent to the inside of the wall of the tube body T on the inside of said wall via the first, inner hot gas outlet 18.

A first temperature sensor 34, which is connected to an analyzer 35 in a manner shown only schematically, is arranged in the first, inner hot gas duct 16. The first temperature sensor 34 detects the temperature of the hot gas flowing in the first, inner hot gas duct and sends a corresponding signal to the analyzer 35. The analyzer 35 can set or change the setting of the hot gas flow control device 30 and/or of the first flow control device 23 and/or of the blocking device 33 of the first cooling gas duct 32 as a function of the determined measured values.

A second ring channel 20, which is in connection with the feed duct 15 via a second connection duct 19a, is formed at a spaced location radially outside the first ring channel 17. The second connection duct 19a and the second ring channel 20 are part of the outer, second hot gas duct 19, which has, at its lower end, a second hot gas outlet 21, from which a radially inwardly directed hot gas flow is discharged.

The hot gas flow being discharged may have a radial and/or tangential and/or axial component, i.e., a component directed downwardly into the inner space of the tube body T.

As can be seen in FIG. 1, the end of the tube body T being used is arranged between the first hot gas outlet 18 and the second hot gas outlet 21, so that the hot gas being discharged from the first hot gas outlet 18 reaches the inner wall of the tube body T and the hot gas being discharged from the second hot gas outlet 21 reaches the outer wall of the tube body T, the first hot gas outlet 18 and the second hot gas outlet 21 being arranged offset in the longitudinal direction of the tube body T such that the first hot gas outlet 18 is arranged slightly below the second hot gas outlet 21.

A second flow control device 29, which may be, for example, a continuously adjustable blocking device 36 in the form of a slide or a throttle, is arranged at the site at which the second connection duct 19a opens into the feed duct 15. By setting the second flow control device 29 by means of an actuating device 37, which is shown only schematically, a user can set the amount of hot gas that shall flow through the second, outer hot gas duct 19, or whether the second hot gas duct 19 shall be fully blocked.

A cooling gas duct 38, which is shown only schematically and in which a continuously adjustable blocking device 39, for example, in the form of a slide or a throttle, is arranged, opens into the second connection duct 19a downstream of the second flow control device 29. By setting the blocking device 39, a user can set whether a cooler gas, for example, ambient air, shall be added to the hot gas flowing in the second, outer hot gas duct 19, and in what amount, in order to thus set the temperature of the hot gas, which is sent to the inside of the wall of the tube body T on the inside of said wall via the second, outer hot gas outlet 21.

In addition, a second temperature sensor 40, which is connected to the analyzer 35 in a manner shown only schematically, is arranged in the second, outer hot gas duct 19. The second temperature sensor 40 detects the temperature of the hot gas flowing in the second, outer hot gas duct 19 and sends a corresponding signal to the analyzer 35. The analyzer 35 can set or change the position of the hot gas flow control device 30 and/or of the second flow control device 29 and/or of the blocking device 39 of the second cooling gas duct 30 as a function of the determined measured values.

A discharge duct 22, which is likewise designed as a ring channel and through which the hot gas can be removed after acting on the wall of the tube body T, as this is indicated by the arrows A, is arranged radially on the outside of the second ring channel 20.

To heat the wall of a tube body, the latter is first inserted from below with its upper, open end through the insertion opening 12 of the housing 11 and is arranged between the first hot gas outlet 18 and the second hot gas outlet 21, the conical screening element 14, which immerses into the tube body T, being used to align the tube body T. The hot gas is subsequently sent through the first hot gas duct 16 and the first hot gas outlet 18 to the inside of the wall of the tube body T. The hot gas then flows upward into a connection duct 28 between the wall of the tube body T and the first cylinder wall 27, flows around the upper end of the tube body T and enters the discharge duct 22 and is removed from this (arrows A).

At the same time, with the blocking device 36 being at least partially opened, the hot gas enters the second hot gas duct 19 and is discharged at the second hot gas outlet 21 thereof and is admitted to the outside of the wall of the tube body T and heats same. The hot gas directly enters the discharge duct 22 and is removed from this.

The tube body T is subsequently removed from the heating device downwardly and closed in the usual manner in a downstream pressing station.

While specific embodiments of the invention have been shown and described in detail to illustrate the application of the principles of the invention, it will be understood that the invention may be embodied otherwise without departing from such principles.

1. A heating device for heating the edges of a filling opening of a tube comprising an individual tubular tube body by means of hot gas, the heating device comprising:
a hot gas nozzle comprising:
a first nozzle section, which can be inserted into an inner space of the tube body and which has a first hot gas duct with at least one first hot gas outlet, which can be arranged within the inner space of the tube body, and by means of which hot gas can be sent to the inner wall of the tube body has
a second nozzle section, which has a second hot gas duct with at least one second hot gas outlet, which can be arranged on the outside of the wall of the tube body and by means of which hot gas can be sent to the outer wall of the tube body; and
a flow control device arranged in the first hot gas duct or in the second hot gas duct or in the first hot gas duct and in the second hot gas duct.

2. A heating device in accordance with claim 1, wherein the flow control device has a continuously adjustable blocking device.

3. A heating device in accordance with claim 1, further comprising a cooling gas duct, through which a cooler gas can be added to the hot gas flowing in the hot gas duct, that opens in the first hot gas duct or in the second hot gas duct or opens in both the first hot gas duct and the second hot gas duct downstream of the flow control device.

4. A heating device in accordance with claim 3, further comprising an adjustable blocking device arranged in the cooling gas duct.

5. A heating device in accordance with claim 1, further comprising a temperature sensor, for detecting the temperature of the gas flowing in the hot gas duct, arranged in the first hot gas duct or in the second hot gas duct or opens in both the first hot gas duct and the second hot gas duct.

6. A heating device in accordance with claim 1, wherein the first hot gas duct and the second hot gas duct are in connection with a common feed duct, in which the hot gas can be fed.

7. A heating device in accordance with claim 6, further comprising a hot gas flow control device arranged in the feed duct.

8. A heating device in accordance with claim 1, wherein the first hot gas outlet is arranged offset in the longitudinal direction of the tube body in relation to the second hot gas outlet.

9. A heating device in accordance with claim 8, wherein the first hot gas outlet is arranged under the second hot gas outlet.

10. A heating device in accordance with claim 1, wherein the first nozzle section is arranged radially within the second nozzle section.

11. A heating device in accordance with claim 1, wherein the hot gas leaving the first hot gas outlet and the hot gas leaving the second hot gas outlet can be removed by means of a common discharge duct.

12. A heating device in accordance with claim 11, wherein the discharge duct at least partially surrounds the hot gas nozzle.

13. A heating device in accordance with claim 2, further comprising a cooling gas duct, through which a cooler gas can be added to the hot gas flowing in the hot gas duct, that opens in the first hot gas duct or in the second hot gas duct or opens in both the first hot gas duct and the second hot gas duct downstream of the flow control device.

14. A heating device in accordance with claim 13, further comprising an adjustable blocking device arranged in the cooling gas duct.

15. A heating device in accordance with claim 14, further comprising a temperature sensor, for detecting the temperature of the gas flowing in the hot gas duct, arranged in the first hot gas duct or in the second hot gas duct or opens in both the first hot gas duct and the second hot gas duct.

16. A heating device in accordance with claim 15, wherein the first hot gas duct and the second hot gas duct are in connection with a common feed duct, in which the hot gas can be fed.

17. A heating device in accordance with claim 16, further comprising a hot gas flow control device arranged in the feed duct.

18. A heating device in accordance with claim 17, wherein:
the first hot gas outlet is arranged offset in the longitudinal direction of the tube body in relation to the second hot gas outlet;
the first hot gas outlet is arranged under the second hot gas outlet.

19. A heating device in accordance with claim 18, wherein the first nozzle section is arranged radially within the second nozzle section.

20. A heating device in accordance with claim 17, wherein:
the hot gas leaving the first hot gas outlet and the hot gas leaving the second hot gas outlet can be removed by means of a common discharge duct; and
the discharge duct at least partially surrounds the hot gas nozzle.
